(19) United States
(12) Patent Application Publication
(10) Pub. No.: US 2005/0262100 A1
(43) Pub. Date: Nov. 24, 2005

(54) System and method for context propagation in application servers and transaction-based systems

(75) Inventor: Andrew Piper, Pleasanton, CA (US)

Correspondence Address: FLIESLER MEYER, LLP, FOUR EMBARCADERO CENTER, SUITE 400, SAN FRANCISCO, CA, 94111, US

(73) Assignee: BEA SYSTEMS, INC., San Jose, CA (US)

(21) Appl. No.: 11/129,899

(22) Filed: May 16, 2005

Related U.S. Application Data
(60) Provisional application No. 60/572,647, filed on May 19, 2004.

(51) Int. Cl. G06F 7/00

(52) U.S. Cl. 707/10

(57) ABSTRACT

A system and method is provided for context propagation within application servers, messaging systems, and transaction-based systems. Context Areas allow users, both internal and external to the system, to associate information with an application which is then carried along with every request. Downstream components can add to or modify this information, so that it can be carried back to the originator. Common use-cases for this functionality include diagnostics monitoring, application transactions, application load-balancing, and indeed any situation where information needs to be carried out-of-band. The ability to propagate out-of-band information prevents the pollution of user APIs and also allows the adding of information to read-only (i.e. 3rd-party) components. A system and method for context propagation in application servers and transaction-based systems.

### CLAIM OF PRIORITY

This application claims priority from provisional application entitled SYSTEM AND METHOD FOR CONTEXT PROPAGATION IN APPLICATION SERVERS AND TRANSACTION-BASED SYSTEMS, Application No. 60/572,647, filed May 19, 2004, by Andrew Piper (Atty. Docket No.: BEAS-01548US0), and incorporated herein by reference.

### FIELD OF THE INVENTION

The invention is related generally to application servers, messaging systems, and transaction-based systems, and specifically to a system and method for context propagation in those systems.

### BACKGROUND

The Java programming language, and the Java 2 Enterprise Edition (J2EE), provide a framework for the development of multi-tiered or multi-layered software applications. These applications utilize standard system-wide services such as the security service and transaction services. Examples of J2EE software development suites include the WebLogic Server (WLS) and WebLogic Integration (WLI) products from BEA Systems, Inc. Software developers can use these development suites to develop complex applications which will be deployed on an application server, and which will in turn use components from a variety of sources—perhaps a different subsystem of that development suite, or an in-house-developed component, or a third-party component.

However, it is not a trivial matter to integrate all of these different components into the final application. In many instances the application requires access to data that cannot realistically be declared as parameters on every method for every component. While some security and transaction components provide the ability to add context information that can be understood by the application server framework, traditional development suites lack the ability to extend this feature to add context that is specific to a particular application.

One technique to overcome this limitation is to add parameters to each interface in the system. However, this is difficult and sometimes impossible when third-party components must be integrated. Other techniques rely on central security principals, or sophisticated software workarounds, such as using Portable Interceptors.

One approach currently being developed within the Java software community is the Java Community Process Work Areas technique, commonly referred to as the JSR-149 specification, and incorporated herein by reference. The Work Area specification allows developers to define properties as an application context, wherein that application context can then flow across remote requests, and can allow downstream components to work within the context of a specific invoking client. Particularly, Work Areas allow J2EE components to set and to retrieve properties into and from a distributed context defined by a particular application, and associated with a particular request.

However, the above-described techniques, including JSR-149, do not allow for much flexibility. They do allow, for example, call parameters in RMI to be understood which are not part of the API. Applications contexts can also be propagated so that the API need not be reprogrammed at each step. However these techniques cannot easily be extended to, for example, an ability to distribute diagnostic information throughout the enterprise. What is needed is a more flexible means by which information can be communicated into the system and can then be circulated throughout the system, for diagnostic and other purposes.

### SUMMARY

In accordance with an embodiment of the invention, a system and method is provided for context propagation within application servers, messaging systems, and transaction-based systems. Context Areas allow users, both internal and external to the system, to associate information with an application which is then carried along with every request. Downstream components can add to or modify this information, so that it can be carried back to the originator. Common use-cases for this functionality include diagnostics monitoring, application transactions, application load-balancing, and indeed any situation where information needs to be carried out-of-band. The ability to propagate out-of-band information prevents the pollution of user APIs and also allows the adding of information to read-only (i.e. 3rd-party) components.

The Context Areas technique may also be used for side-by-side deployment, in which different versions of an application are deployed and coexist within a particular environment.

In addition, a developer can specify the destination for the request, and how something should be propagated.

Additionally, the system can provide transport-specific context information for use in marshaling requests on those transports, so that the technique may be used with, for example, JMS, SOAP, or servlets.

The system is particularly useful for customers, layered products (in particular integration products), and subsystems that have requirements for transmitting out-of-band information.

### BRIEF DESCRIPTION OF THE FIGURES

FIG. 1 shows an illustration of an environment in accordance with an embodiment of the invention, that allows for context propagation.

FIG. 2 shows an illustration of a ContextArea as it may be used for context propagation in accordance with an embodiment of the invention.

FIG. 3 shows a flowchart of a method for context propagation in a client/server environment in accordance with an embodiment of the invention.

FIG. 4 shows a flowchart of a method for out-of-band context propagation in accordance with an embodiment of the invention.

### DETAILED DESCRIPTION

In accordance with an embodiment of the invention, a system and method is provided for context propagation within application servers, messaging systems, and transaction-based systems. Context Areas allow users, both internal and external to the system, to associate information with an application which is then carried along with every request. Downstream components can add to or modify this information, so that it can be carried back to the originator. Common use-cases for this functionality include diagnostics monitoring, application transactions, application load-balancing, and indeed any situation where information needs to be carried out-of-band. The ability to propagate out-of-band information prevents the pollution of user APIs and also allows the adding of information to read-only (i.e. 3rd-party) components.

The Context Areas technique may also be used for side-by-side deployment, in which different versions of an application are deployed and coexist within a particular environment.

In addition, a developer can specify the destination for the request, and how something should be propagated.

Additionally, the system can provide transport-specific context information for use in marshaling requests on those transports, so that the technique may be used with, for example, JMS, SOAP, or servlets.

The system is particularly useful for customers, layered products (in particular integration products), and subsystems that have requirements for transmitting out-of-band information.

Examples of potential uses for the system include:

An administrator of an application server system needs to determine why a particular application function is taking an inordinately long time. The administrator configures the system to add diagnostic information to requests entering the system via the ContextArea subsystem. Aspects installed at appropriate pointcuts in the system add timestamp information to the ContextArea context and the resultant data is harvested by the administrator. This is also known as request “dying”.

An application client needs to load-balance requests to the server. The ContexArea subsystem is used to add load information to responses so that the client can make appropriate load-balancing decisions.

To improve performance the EJB CMP container changes the cache set it uses based on hints from a client propagated via an internal context.

The self-tuning functionality dynamically categorizes requests based on priority.

An integrated services vendor (ISV) needs to integrate their transactional product with an application server, (for example WLS). The ISV uses the ContextArea APIs to add application transactions to requests into WLS. The ISV then correlates requests coming out of WLS with their application transactions by examining the appropriate ContextArea context.

A customer wishes to filter SOAP requests based on application data. The customer adds application data to all SOAP requests using the ContextArea subsystem. Since the data is transaparent at the SOAP level, they can filter using standard SOAP tools.

A customer wishes to propagate a global security token throughout his network (e.g. Kerberos Ticket). This token can be used to interact with foreign servers.

A customer wishes to move his application which uses the ContextArea APIs, from one brand of application server to another.

Other uses and applications of the systems and methods may be made in addition to those described above. It will be evident that the use of the system is not limited to the specific examples described herein, but that other uses may be developed within the spirit and scope of the invention.

The following terms are used within this description:
RMI—Remote Method Invocation
WLS—WebLogic Server.
WorkContextMap—A set of thread-local properties.
Context Data/Runtime Context/WorkContext—A thread-local property value
Application Transactions—Extended transactions as defined by JSR-95.
UserContextArea—A set of, possibly overlapping, WorkContextMaps.
Overlay/override—The temporary hiding of a WorkContext by another with the same name.

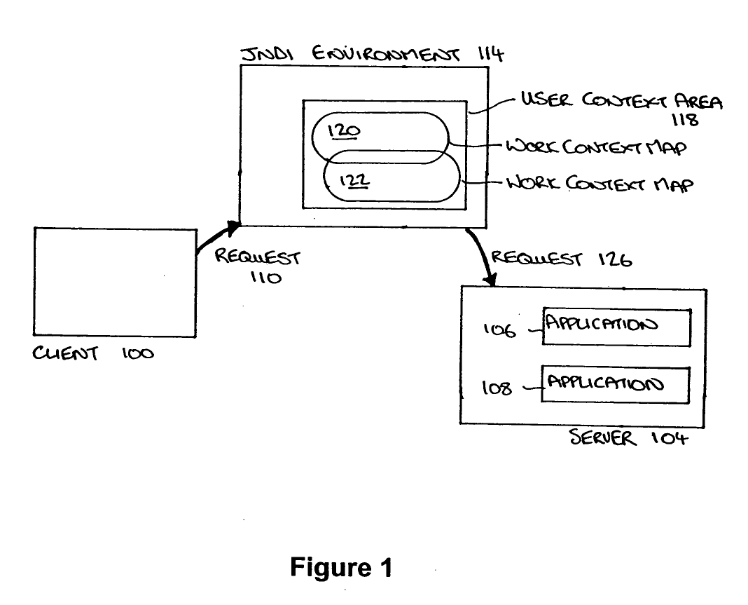

FIG. 1 shows an illustration of an environment in accordance with an embodiment of the invention, that allows for context propagation. As shown in FIG. 1, a client 100 makes requests 110 upon one or more applications 106, 108 executing at a server 104. A User ContextArea 118 is provided as part of the client or applications JNDI environment, and can be accessed through JNDI. The User ContextArea includes a set of, possible overlapping User Context Maps 120, 122. The User Context Map is a set of lower-level API's that allow contexts to be propagated with different kinds of requests.

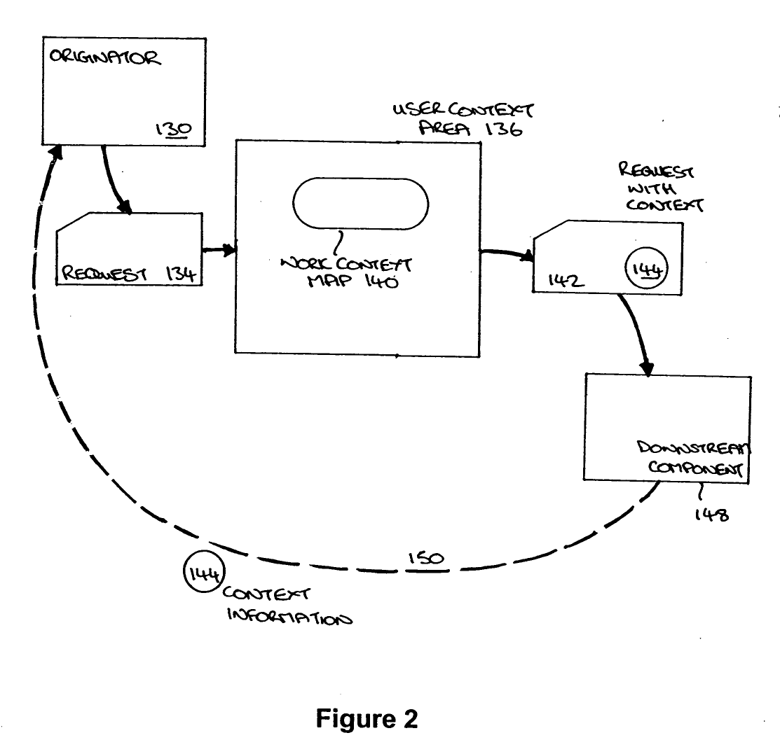

FIG. 2 shows an illustration of a ContextArea as it may be used for context propagation in accordance with an embodiment of the invention. As shown in FIG. 2, the ContextArea 136 allows originators 130 of a request 134, to associate context 144 with the request via the WorkContextMap 140. The context may then be propagated throughout the system and to other components. A downstream component 148 may modify or add to the context. This modified context may then be communicated out-of-band 150, back to the originator of the request.

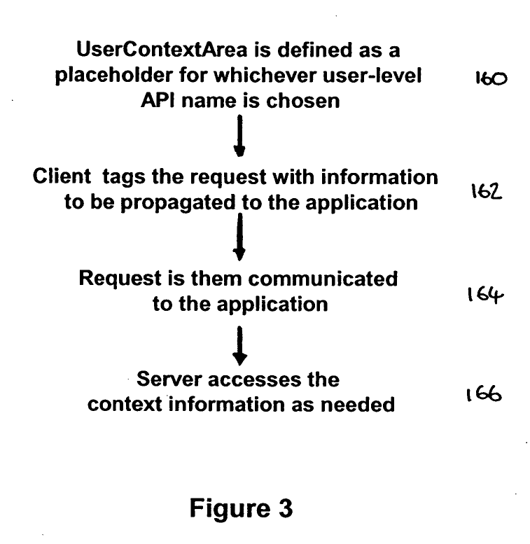

FIG. 3 shows a flowchart of a method for context propagation in a client/server environment in accordance with an embodiment of the invention. As shown in FIG. 3, in step 160, the UserContextArea is defined as a place holder for which ever user-level API name is chosen. In step 162, the client tags the request with information to be propagated to the application. In step 164, the request is then communicated to the application. In step 166, the server accesses the context information as needed.

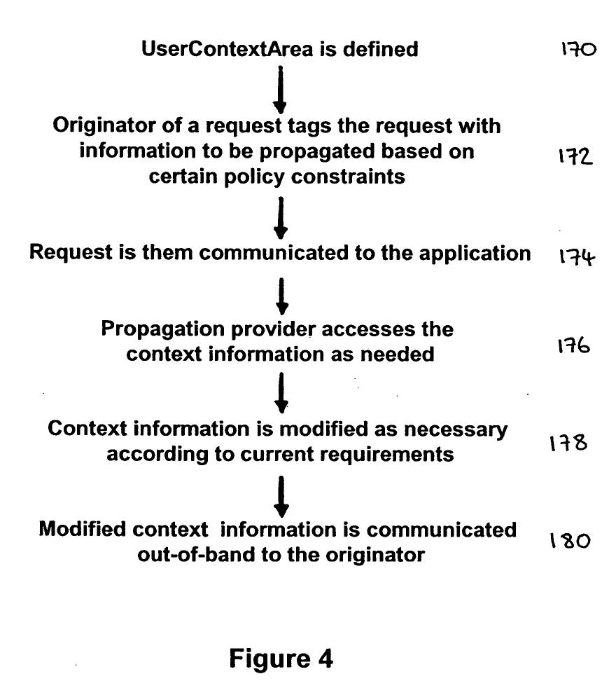

FIG. 4 shows a flowchart of a method for out-of-band context propagation in accordance with an embodiment of the invention. As shown in FIG. 4, in step 170, the UserContextArea is defined. In step 172, the originator of a request tags the request with information to be propagated based on certain policy constraints. In step 174, the request is then communicated to the application. In step 176, the propagation provider accesses the context information as needed. In step 178, the context information is modified as necessary according to current requirements. In step 180, the modified context information is communicated out-of-band to the originator.

Example Implementation

In accordance with an embodiment, the system and method includes a number of features which can be used to manipulate the ContextAreas and ContextMaps.

UserContextArea

This feature allows users to create, read, modify and delete Context Areas as defined by JSR-149. UserContextArea is a placeholder for whatever user-level API name is chosen. UserContextArea provides end-users, ISVs and others mechanisms for tagging certain requests (whether remote or local) and propagating that information based on certain policy constraints. UserContextArea is part of a client or applications JNDI environment and can be access through JNDI.
UserContextArea rc=(UserContextArea) new InitialContext( ).lookup(“java:comp/UserContextArea”);
   WorkContextMap

This feature allows internal users to create, read, modify and delete contexts that will be propagated with different kinds of requests. WorkContextMap is a set of lower-level APIs for internal consumers of this service. It can be accessed through a helper:
WorkContextMap rc=WorkContextMapHelper. getWorkContextMapHelper( ).getworkContextMap( );
   ContextArea SPI

The feature allows propagation providers to get at the underlying propagation contexts for marshaling in transport-specific ways.

Propagate User-Defined Information (Internal)

Users in the this context means the actual server (for example WLS) subsystems and layered products. In some embodiments it is possible to propagate user-defined data across all request scopes implemented by the server. This includes:
WorkManager invocations, i.e. transfer of information between threads.
RMI invocations.
Transactions. JTA currently has its own mechanism for propagating per-transaction information. Context information may be carried along with the current transaction and not propagated if the transaction is suspended or terminated.
JMS. JMS has a number of different data-passing models including queues and topics, which may be dealt with individually.
SOAP. In particular JAX-RPC.
User.
MIME-HEADERS. Cookies coming in on an HTTP request, or mime headers coming over SMTP can be converted into an appropriate context and propagated throughout the system. It is also possible for 3rd-party load-balancers to synthesize these headers for injection into the server.

It may be possible to use these modes in combination with each other. Although it is possible to have “Local” propagation, the use of ThreadLocal variables is equivalent and preferred. The default propagation mode will be “Remote” which will include RMI, JMS, SOAP and MIME-HEADERS.

It is not desirable to propagate arbitrary Java data, since this imposes too many performance constraints on the underlying implementation and also is difficult to access in non-Java contexts (e.g. C++ or XML). Interfaces can be provided to allow users of the API to define relatively complex structures for propagation. These structures can be built up from types allowed by java.io.DataOutput and java.lang.String. In particular it is not desirable to pass arbitratrary java.io.Serializable or java.io.Externalizable data.

There is no underlying evolution mechanism for data defined in this way. Clients that have particular interoperability requirements should define their own version information. Version information can be encoded in the context name.

In some embodiments there is a mechanism for WorkContext implementations (for instance by implementing a NotifiableWorkContext) to get a callback when the scope changes. This allows contexts to capture fork points effectively.

Propagate User-Defined Information (External)

Users in this context mean application programmers and ISVs. In some embodiments it is possible to propagate user-defined data as defined above. In addition it is possible to propagate arbitrary Java data although this imposes performance constraints on the underlying implementation. The propagation of external user-defined data will rely on the APIs implemented to support propagation of internal user-defined data.

The application-level API can be one of:
JSR-149;
Existing ContextArea APIs; or
A server (e.g. WebLogic) specific API.

In some embodiments there is also a mechanism for propagating simple datatypes using this mechanism. Users should not be constrained to using Serializable. It may be possible to support arbitrary schema elements for user datatypes.

Internal SPI

It must be possible for internal implementors of this service to import and export context information easily. These providers should only have to provide implementations for data marshaling. Import and export to/from thread-local storage can be provided by the SPI. At the SPI-level it is intended that the functionality provided be powerful enough to support transactions, although it is not intended to switch transactions to this mechanism.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A system for context propagation within application servers, comprising:
a first component for communicating requests to an application executing at an application server; and
a ContextArea that allow users to associate context information with an application which is then propagated with every request.

2. The system of claim 1 wherein the first component is a client.

3. The system of claim 1 wherein the system includes a second component down-stream that can modify the context information.

4. The system of claim 3 wherein the modified context information is communicated back to the first component using an out-of-band communication.

5. The system of claim 1 wherein the system can provide transport-specific context information for use in marshaling requests on those transports

6. The system of claim 3 wherein an administrator can configure the system to add diagnostic information to request entering the system.

7. A method for context propagation within application servers, comprising the steps of:
communicating requests from a first component to an application executing at an application server; and
mapping the requests at a ContextArea that allow users to associate context information with an application which is then propagated with every request.

8. The method of claim 7 wherein the first component is a client.

9. The method of claim 7 wherein the system includes a second component down-stream that can modify the context information.

10. The method of claim 9 wherein the modified context information is communicated back to the first component using an out-of-band communication.

11. The method of claim 7 wherein the system can provide transport-specific context information for use in marshaling requests on those transports

12. The method of claim 9 wherein an administrator can configure the system to add diagnostic information to requests entering the system.
